(19) United States
(12) Patent Application Publication
(10) Pub. No.: US 2024/0079821 A1
(43) Pub. Date: Mar. 7, 2024

(54) ELECTRIC CONNECTOR ASSEMBLY

(71) Applicant: TE Connectivity India Private Limited, Bangalore (IN)

(72) Inventors: Subhas Shrikant Hegde, Bangalore (IN); Kashyap Prakash B., Bangalore (IN); Danappa Hugar, Bangalore (IN); Amrutha Rao C. H., Bangalore (IN); Supriya S, Bangalore (IN)

(21) Appl. No.: 18/460,745

(22) Filed: Sep. 5, 2023

(30) Foreign Application Priority Data
Sep. 7, 2022 (IN) 202241051031

(51) Int. Cl. H01R 13/629

(52) U.S. Cl. CPC H01R 13/629; H01R 13/639

(57) ABSTRACT

A connector assembly includes two electric connectors that are configured to be plugged together in a plug-in direction and rotated relative to one another in a direction of rotation into a coupled state, wherein one of the two electric connectors includes a contact and the other one of the two electric connectors includes a mating contact. A mechanical guiding system guides the movement of the two electric connectors relative one another in the plug-in direction and the movement of the two electric connectors relative to one another in the direction of rotation. The mechanical guiding system mechanically couples the movement in the direction of rotation with a movement against the plug-in direction. In the coupled state, the contact and the mating contact are pressed against each other against the plug-in direction.

### CROSS REFERENCE TO RELATED APPLICATIONS

This application claims the benefit of IN Application No. 202241051031, filed on 7-Sep.-2022, the subject matter of which is herein incorporated by reference in its entirety.

### BACKGROUND OF THE INVENTION

The subject matter herein relates to electric connector assemblies and methods of assembling electric connector assemblies.

In some applications, electric contact assemblies need to withstand very high mating cycles. One such example is in electric vehicles, in particular if swappable batteries are used, which need to be disconnected and reconnected to the electric vehicle if swapped. The number of mating cycles is often limited by the wear and tear on the electric contacts.

There is a need for an electric contact assembly, which allows for very high mating cycles by reducing the wear and tear on the contact surfaces.

### BRIEF DESCRIPTION OF THE INVENTION

In one embodiment, a connector assembly is provided including two electric connectors that are configured to be plugged together in a plug-in direction and rotated relative to one another in a direction of rotation into a coupled state, wherein one of the two electric connectors includes a contact and the other one of the two electric connectors includes a mating contact. A mechanical guiding system guides the movement of the two electric connectors relative one another in the plug-in direction and the movement of the two electric connectors relative to one another in the direction of rotation. The mechanical guiding system mechanically couples the movement in the direction of rotation with a movement against the plug-in direction. In the coupled state, the contact and the mating contact are pressed against each other against the plug-in direction.

In another embodiment, a method for coupling two electric connectors of a connector assembly is provided including the steps of moving the two electric connectors towards each other in a plug-in direction, thereby plugging the two connectors together, and rotating one of the two electric connectors relative to the other one of the two electric connectors in a direction of rotation into a coupled state. The relative rotational movement of the two connectors along the direction of rotation is mechanically coupled to a relative movement of the two connectors away from one another against the plug-in direction. A contact of one of the two electric connectors is automatically moved towards a mating contact of the other one of the two electric connectors against the plug-in direction during the relative rotational movement in the direction of rotation until, in a coupled sate of the connector assembly the contact and the mating contact are pressed together.

### BRIEF DESCRIPTION OF THE DRAWINGS

FIG. 1 shows a schematic perspective view of an embodiment of an electric connector assembly in an unplugged state in accordance with embodiments herein.

FIG. 2 shows a schematic side view of the embodiment of FIG. 1 in the unplugged state in accordance with embodiments herein.

FIG. 3 shows a schematic side view of the embodiment of FIG. 1 in a coupled state in accordance with embodiments herein.

FIG. 4 shows a schematic cut side view of another embodiment of the electric connector assembly in the coupled state in accordance with embodiments herein.

FIG. 5 shows a schematic cut view along line V-V in FIG. 4 of the electric connector assembly before reaching the coupled state in accordance with embodiments herein.

FIG. 6 shows a schematic view along line VI-VI of FIG. 4 of the electric connector assembly in the coupled state in accordance with embodiments herein.

FIG. 7 shows a schematic perspective view of a connector of the embodiment of FIG. 4 in accordance with embodiments herein.

FIG. 8 shows detail VIII of FIG. 7 in accordance with embodiments herein.

FIG. 9 shows detail IX of FIG. 7 in accordance with embodiments herein.

FIG. 10 shows a schematic perspective view of another connector of the embodiment of FIG. 4 in accordance with embodiments herein.

FIG. 11 shows detail IX of FIG. 10 in accordance with embodiments herein.

FIG. 12 shows detail XII of FIG. 10 in accordance with embodiments herein.

FIG. 13 shows a schematic perspective view of an embodiment of an electric contact of an electric connector assembly in accordance with embodiments herein.

FIG. 14 shows a schematic perspective view of an embodiment of an electric contact of an electric connector assembly in accordance with embodiments herein.

### DETAILED DESCRIPTION OF THE INVENTION

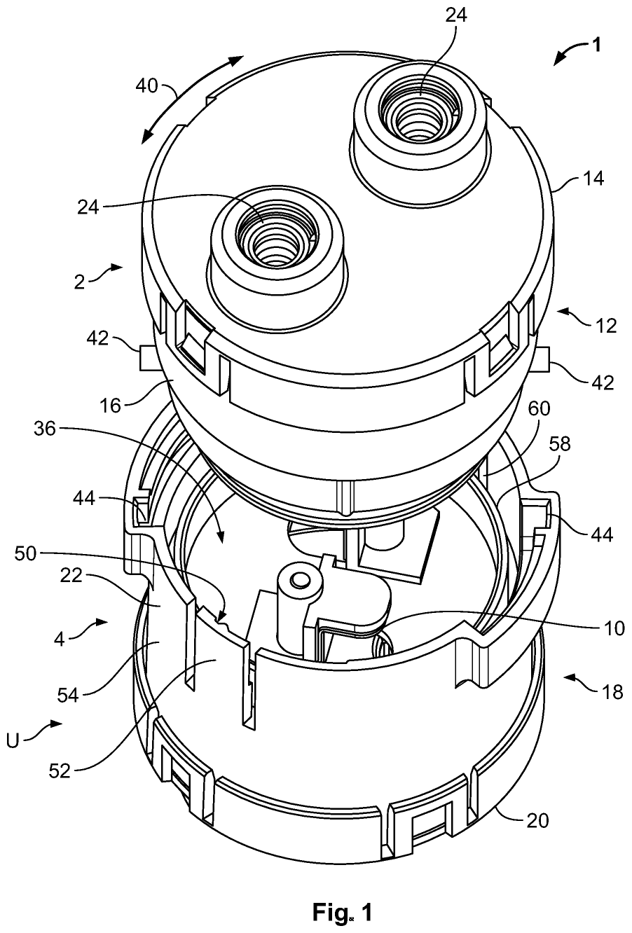

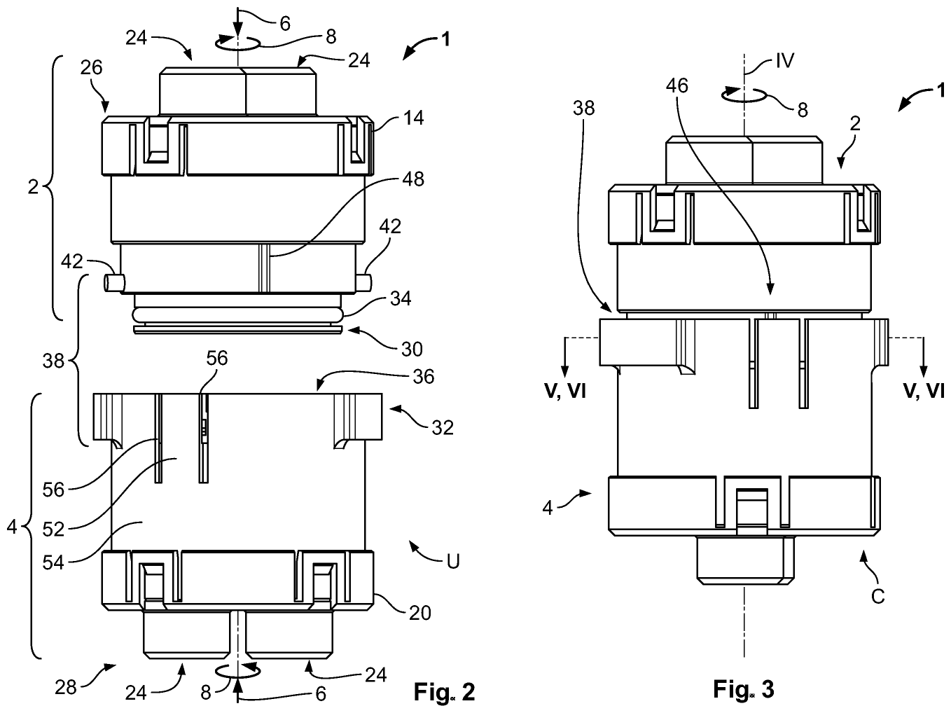

First, the structure of an embodiment of an electric connector assembly 1 is explained with reference to FIGS. 1 and 2.

The electric connector assembly 1 shown exemplarily in FIGS. 1 and 2 comprises two connectors 2, 4 that are complementary to one another.

Only by way of example, connector 2 is shown as a male connector which is inserted into the connector 4, which only by way of example is shown as a female connector. As this distinction is not of importance to the functioning of the electric connector assembly 1 as further explained in the following, no further terminological distinction is made between the connectors 2, 4.

In FIGS. 1 and 2, the electric connector assembly 1 is shown in the unmated or, synonymously, unplugged state U, where the connectors 2, 4 are separate from one another but already in position to be plugged together. For coupling the two connectors 2, 4, they are first moved towards each other and plugged together in a plug-in direction 6, and then rotated relative to one another around the plug-in direction 6 as indicated by arrow 8. The plug-in direction 6 is directed from each connector 2, 4 to the respective other connector 4, 2. It corresponds to the direction, in which the connectors 2, 4 are moved towards each other.

For connector 4, the plug-in direction 6 points to connector 2, whereas the plug-in direction 6 of connector 2 points to connector 4. In various embodiments, the connectors 2, 4 are moved only translationally with respect to one another along the plug-in direction 6. Nonetheless, the movement along the plug-in direction 6 may also comprise a rotatory component, for example, the plug-in direction 6 may extend along a helix.

The direction of rotation 8 is the direction, around which each connector is rotated when being coupled together. For example, the direction of rotation 8 for each connector may be clockwise relative to the other connector.

The connectors 2, 4 may have a substantially circular footprint and/or be of cylindrical shape with an outer axis parallel to the plug-in direction 6.

Each connector 2, 4 comprises at least one electric contact, and may have two or more electric contacts. In FIG. 1, only one contact is visible, namely, contact 10 of connector 4. Connector 2 may comprise a housing 12, which may consist of two parts 14, 16. Connector 4 may comprise a housing 18, which in turn may comprise two parts 20, 22.

The parts 14, 20, may be configured as a cover comprising one or more openings 24 through which a cable (not shown) may be inserted into an interior (not shown) of the respective connector 2, 4 to be connected to the one or more contacts. The number of openings 24 may correspond to the number of contacts in each of the connectors 2, 4. The opening 24 may be configured to sealingly engage the cable, e.g., by comprising a rubber or elastomeric seal.

In the embodiment shown in FIGS. 1 and 2 the parts 14, 20 are clipped onto the parts 16, 22.

The respective ends of the connectors 2, 4, which are located at the cable side of the respective connector 2, 4, i.e. the side where the opening 24 is located, are denoted as the distal (cable) end 26, 28 of the respective connector 2, 4. A respective proximal (connector) end 30, 32 of the connector 2, 4 is formed at an end thereof facing the respective other connector 4, 2. The distal ends 26, 28 face against the plug-in direction 6, the proximal ends 30, 32 face in the plug-in direction 6 of the respective connector 2, 4.

The housing 18 of course does not need to comprise two parts. It can be a monolithic body or, alternatively, comprise more than two parts. The one or more contact is attached to the respective housing 12, 18 of connector 2, 4, e.g., by screws or rivets (not shown).

At least one of the connectors 2, 4 may further comprise a sealing element 34, such as an 0-ring, which is arranged to sealingly engage the respective other connector 4, 2. Just by way of example, the sealing element 34 is shown to be attached to the connector 2. Instead, the sealing element 34 may also be mounted on connector 4, or a sealing element may be mounted on each of the connectors 2, 4.

The sealing element 34 is configured to establish a sealing in the coupled state between the connectors 2, 4 to seal off a connector volume 36, in which the contacts of the connectors 2, 4 are arranged.

The electric connector assembly 1 further comprises at least one mechanical guiding system 38 which is configured to guide the motion of the connectors 2, 4 relative to one another. As explained above, this relative motion may first be along the plug-in direction 6 and then along the rotation direction 8.

For example, there may be two or three guiding systems spaced apart, such as equidistantly, along a circumferential direction 40. The circumferential direction 40 may, for example, correspond to the rotational direction 8 about the plug-in direction 6. In the embodiment of FIGS. 1 to 3, two guiding systems 38 are shown opposite one another. The guiding system may be arranged on an outside of the connector assembly 1.

Each guiding system 38 may comprise a guiding protrusion 42, which may be formed as a pin, and a guiding groove 44. The guiding groove 44 is configured to receive the guiding protection 42 upon relative movement of the connectors 2, 4 in the plug-in direction 6 from the uncoupled state U. In such a configuration, each guiding system 38 forms a sliding-block or slotted guide.

FIG. 3 shows the electric connector assembly 1 in the operational or coupled state C, where the connectors 2, 4 are fully mated and the electric connector assembly 1 is operational.

The electric connector assembly 1 may comprise a locking system 46, which locks or latches the connectors 2, 4 in the coupled state C.

In various embodiments, more than one locking system 46 is provided. For example, there may be two or more locking systems, such as evenly distributed along the circumferential direction 40.

The locking system 46 is exemplarily described with reference to FIGS. 1, 2.

The locking system 46 may comprise a locking protrusion 48 and a locking recess 50 which are complementary to one another. In the coupled state C, the locking protrusion 48 is received in the locking recess 50. Just by way of example, the locking protrusion 48 is located on connector 2, whereas the locking recess 50 is located on connector 4. Of course, the locking protrusion 48 may also be located on connector 4, whereas the locking recess 50 may be located on connector 2.

The locking recess 50 or, alternatively, the locking protrusion 48 may be located on a locking tongue 52, which is formed by one of the housings 12, 18, such as the housing 18 of the female connector 4. The locking tongue 52 may be formed by a circumferential wall 54 with which it may be joined by a base section and from which it may be separated by two slots 56. The slots 56 may extend along the plug-in direction 6 and be open at the proximal end 32.

The circumferential wall 54 may be an outer wall of the connector 4. In this case, the connector 4 may also comprise an inner wall 58 which is surrounded by the circumferential wall 54 and separated therefrom by a substantially annular groove 60. The sealing element 34 may be, in the coupled state C, in sealing engagement with the inner wall 58. Thus, any holes in the circumferential wall 54, such as the slots 56 and/or the groove 44, do not affect the sealing of the connect-or volume 36.

As shown in FIG. 1, the circumferential wall 54 may extend in the plug-in direction 6 beyond the inner wall 58.

The coupled state C is reached at the end of the relative rotational movement 8 of the two connectors 2, 4, which may require that the relative movement in the plug-in direction 6 of the two connectors 2, 4 be completed first.

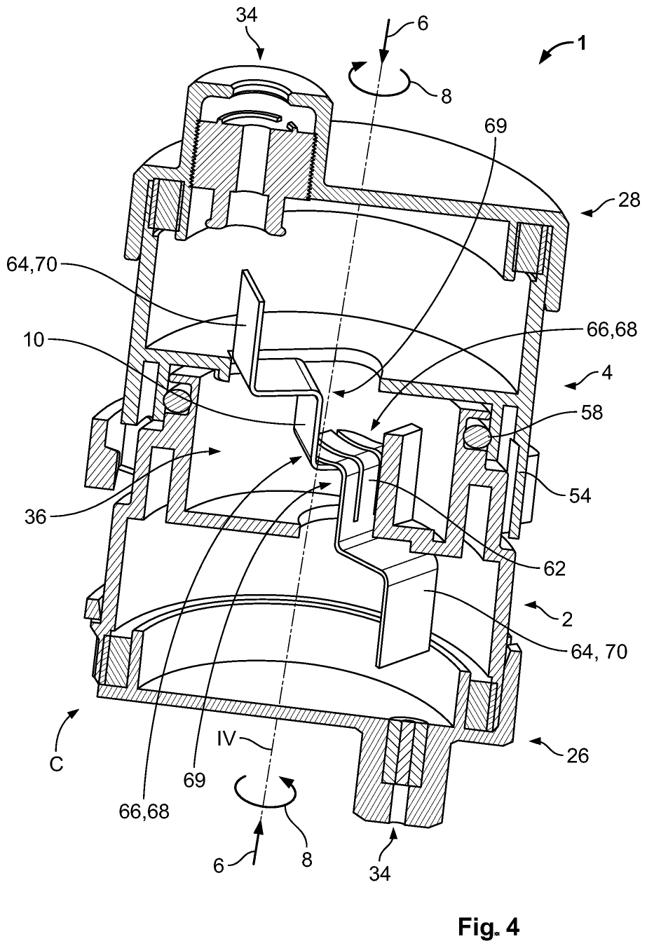

The coupled state C of the electric connector assembly 1 is further explained with reference to the cut side view of FIG. 4. The embodiment of FIG. 4 differs from the embodiment of FIGS. 1 to 3 in that it comprises three guiding systems 38 that are equidistantly spaced in the circumferential direction.

In FIG. 4, contact 10 of connector 4 is shown as it is in contact with a mating contact 62 of connector 2. Each of the contacts 10, 62 may be a stamped and bent metal sheet part. Each contact 10, 62 may comprise a distal end 64 which is located closer to the distal end 26, 28 of the respective connector 2, 4 than a respective proximal end 66 of the contacts 10, 62. The proximal end 66 of a contact 10, 62 faces in the plug-in direction 6, whereas the distal end 64 faces against the plug-in direction 6.

The distal ends 64 of the contacts 10, 62 may be configured for attachment of a conductor (not shown) of a cable (not shown) that reaches through a respective opening 34. The proximal ends 66 of the contacts 10, 62 contact each other. Thus, a contact section 68 of the contact 10, 62 is located at the respective proximal end 66. At each distal end 64 of the contacts 10, 62, a terminal section 70 may be located.

As shown in FIG. 4, the contact section 68 of the contact 62, 10 of one connector 2, 4 is located between the contact section 68 of the respective other connector 4, 2 and the distal end 28, 26 of this other connector 4, 2 in the coupled state C. Thus, the contact section 68 of the contact 10 of the connector 4 is located between the contact section 68 of the contact 62 of the connector 2, and the distal (cable) end 26 of the connector 2. The contact section 68 of the contact 62 of the connector 2 is located between the contact section 68 of the contact 10 of the connector 4 and the distal (cable) end 28 of the connector 4.

In the respective plug-in direction 6 of each connector 2, 4, the contact section 68 of this connector 2, 4 is located behind the contact section 68 of the respective other connector 4, 2.

The contact section 68 of the contacts 10, 62 may extend in a plane which is oriented essentially perpendicular to the plug-in direction 6.

Each contact section 68 may be spaced apart in the plug-in direction 6 from the respective housing 16, 18, to which the contact 10, 62 is attached. Thus, a free space or pocket 69 is generated between the contact section 68 of a contact 10, 62 and its respective housing 18, 16, the pocket extending in the plug-in direction 6 and in the rotational direction 8. The pocket is spaced to receive at least partly a contact section 68 of the contact of the other connector. The pocket 69 is open against the rotational direction 8 so that the mating contact 62, 10 may enter the pocket 69 when the two connectors 2, 4 are moved relative to one another in the rotational direction 8. In the coupled state C, the contact section 68 of the respective other contact 62, 10 is located in the space between the contact section 68 of the contact 10, 62 and the respective housing 16, 18.

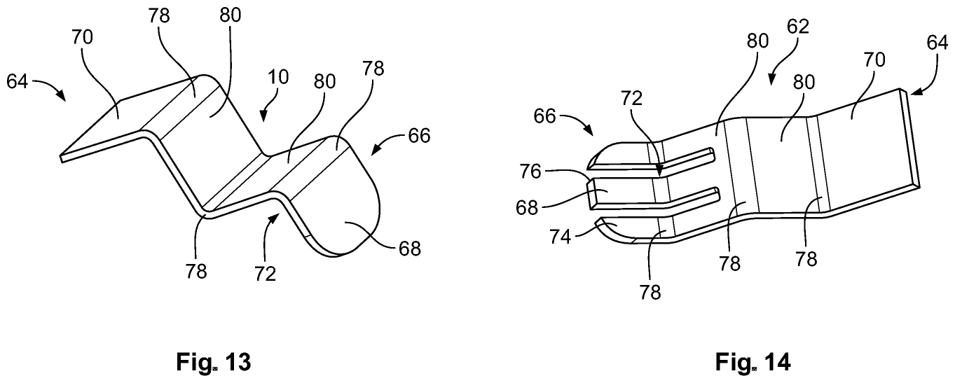

FIGS. 13 and 14 show the contacts 10, 62 without the housings 16, 18. The contact section 68 of each contact 10, 62 comprises a contact surface 72 which faces in the direction of the respective distal end 64 of the contact 10, 62. In a force-free state, at least one contact surface 68 is essentially planar. The contact surface 72 is configured to be contacted by the contact surface 72 of the respective other contact.

In one contact, e.g., contact 10, the contact section 68 may be formed as a single latch or tongue so that the contact surface 72 is an uninterrupted, contiguous surface. In one contact, e.g., contact 62, the contact section 68 and thus the contact surface 72 may be formed by two or more contact tongues. The contact tongues 74 may essentially extend parallel to one another and be separated from one another by slots 76. The contact tongues 74 may extend in the rotational direction 8, their free ends facing in the rotational direction 8.

Each contact 10, 62 may be formed from an elongated piece of metal sheet. Each contact 10, 62 may have multiple folds or bends between the contact section 68 and the terminal section 70. The bend or fold may in particular form an angle of about 90°. In the embodiments shown in FIG. 13, 14, three folds or bends 78 are arranged between the contact section 68 and the terminal section 70, giving the contacts 10, 62 an overall W-shape with an angle of approximately 90° between neighboring legs. One of the two intermediate legs 80, in particular the intermediate leg 80 neighboring the terminal section 70, may be configured to attach the contact 10, 62 to the housing 80. The intermediate leg 80 neighboring the contact section 68 may be used to offset the contact section 68 from the housing and form the pocket 69 as described above, so that the con-tact section 68 of the respective other contact may be moved between the contact section 68 and the respective housing.

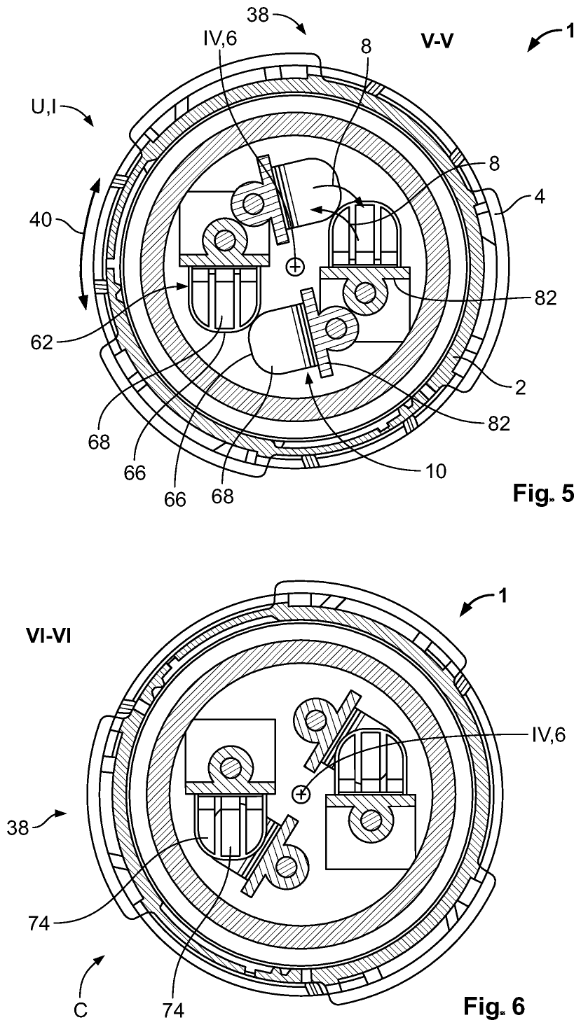

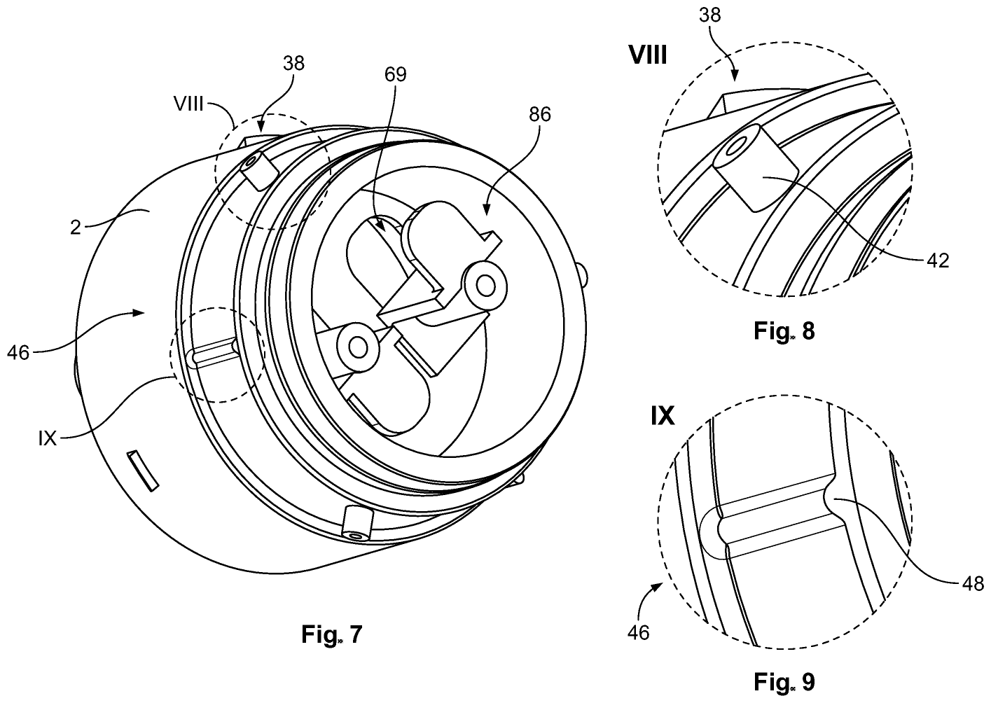

In the following, it is described with reference to FIGS. 5 and 6 how the mating contacts 10, 62 are brought into electric contact with one another when the connector assembly 1 is transferred from the unplugged or unmated state U to the coupled state C.

First, the connectors 2, 4 are moved towards each other in the plug-in direction 6 until an inter-mediate state I is reached at the end of the movement along the plug-in direction 6. In the un-mated state U and in the intermediate state I, the contact sections of the contacts 10, 62 do not overlap in the plug-in direction 6, so that they can be moved past one another when the contacts 2, 4 are moved towards each other and plugged together along the plug-in direction 6. In these states, the proximal ends 66 of the contacts 10, 62 face towards each other in the circumferential direction 40 or the direction of rotation 8, respectively, but are spaced apart from one another in the rotation direction 8.

A support 82 of the housing 2, 4, the support 82 supporting the contact 10, 62, in particular an intermediate leg 80 thereof, is located at a side of the respective contact 10, 62 which faces away from the respective mating contact 62, 10 in the circumferential direction 10 or the direction of rotation 8, respectively. The support 82 may, for example, be a supporting wall which ex-tends in the plug-in direction 6 and abuts the intermediate leg 80 neighboring the contact section 68.

In the intermediate state I, the contact section 68 of the contact 10, 62 of one connector 2, 4 is moved past the respective contact section 68 of the mating contact 62, 10 of the other connect-or 4, 2 and the male connector, e.g., connector 2, may be fully inserted into the female connector, e.g., connector 4. In various embodiments, there is no overlap between mating contact sections 68 in the circumferential direction 10 or the direction of rotation 8, respectively, in the intermediate state I. Thus, the contact section 68 of mating contacts 10, 62 can be rotated towards each other in the circumferential direction 40, or the direction of rotation 8, respectively, into a position in which they overlap in the plug-in direction 6 without their contact sections sliding against each other and creating friction.

The guiding system 38 is configured to couple or combine the rotational movement of the connectors 2, 4 along the direction 8 from the intermediate state I to the coupled state C with a movement against the plug-in direction 6. A movement against the plug-in direction 6 corresponds to a translational or linear movement of the connectors 2, 4 away from each other.

Thus, the contact sections 68 of the contacts 10, 62 are not only moved into an overlap in the plug-in direction 6 by the rotational movement 8, but also moved towards each other and, ultimately, pressed against each other by the simultaneous movement against the plug-in direction.

The overlap of the contact sections 68 in the plug-in direction 6 is accomplished in that each contact 10, 62 is moved into the pocket 69 between the respective other contact 62, 10 and the housing 2, 4 of this respective other connector 2, 4 as shown in FIG. 4.

By providing two or more contact tongues 74, the stiffness of the contact section 68 of one contact 10, 62 may be decreased and its elasticity along the plug-in direction may be increased. To reduce the contact area, which facilitates the break-away of any oxidized layer on the contact surfaces 72, at least one contact section 68 may be provided with one or more beads or bulges. The bulge or bead should project in the plug-in direction of the respective connector.

In the coupled state, the contact section 68 of at least one of the contacts 10, 62 is elastically deflected against the respective plug-in direction 6 to generate a contact force.

In FIG. 10, the connector 4 is shown without any contact element 10.

The support 82 is shown to continue in a further support 84 which is configured to support the contact section 68. The further support 84 is substantially planar, such as with its plane being oriented perpendicular to the plug-in direction 6 and parallel to the rotational direction 8. In the fully assembled connector 4, the contact section 68 is located between the support 84 and the distal end 26 of the connector 4. Both supports 82, 84 are plates that are arranged at a right angle relative to one another and that are monolithically combined. The supports 82, 84 may e.g., be integral parts of a support structure 86 which forms a separate unit that is attached to the housing 18. The contact 10 may be pre-mounted to the support structure 86 and the contact 10 and the support structure 86 may be mounted as a unit in the connector 4. If more than one contact 10 is provided in a connector 4, several identical units may be used.

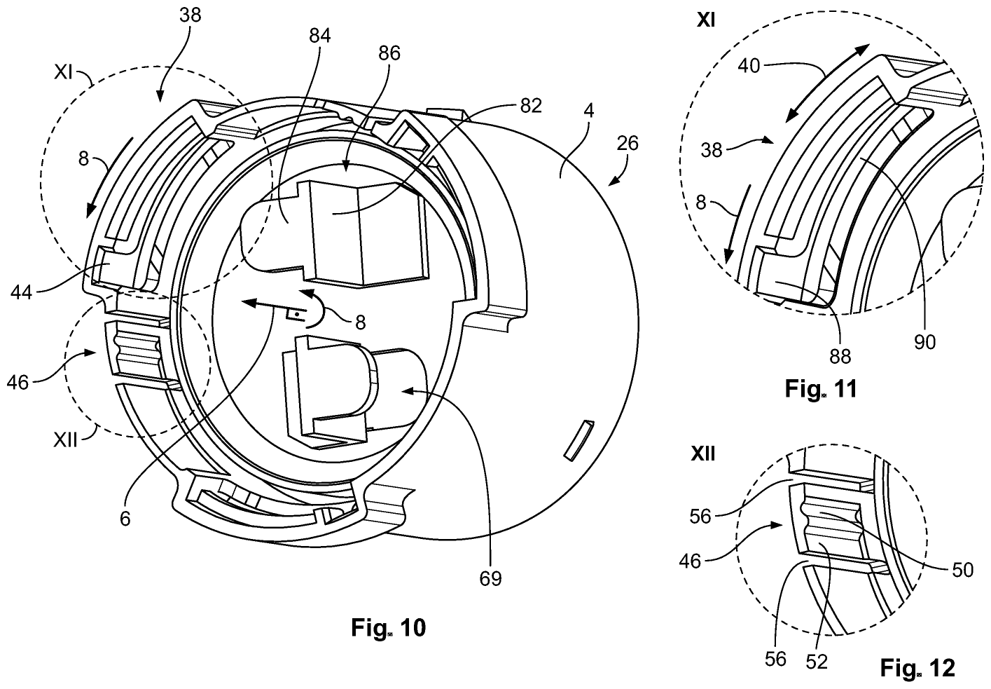

In FIG. 10 and FIG. 11, the guiding system 38 is shown more clearly than in FIGS. 1 and 2.

The guiding groove 44 may comprise a first section 88 and a second section 90. The transition between the first section 88 and the second section 90 may be smooth, e.g., a smooth curve, or, as shown, the first and second section 88, 90 may be at an angle of 90°±15° and be joined by a bend in the guiding groove 44. The first section 88 is configured to guide the relative movement of the connectors 2, 4 from the unmated state U to the intermediate state I. In the first section 88, the guiding groove 44 extends essentially linearly against the plug-in direction 6 of the connector 4. Thus, the guiding protrusion 42 (FIGS. 1 and 2) is guided by the first section 88 in the plug-in direction 6 of the other connector 2. The second section 90 of the guiding groove 44 extends away from the first section 88 against the direction of rotation 8. At the same time, the second section 90 extends at least section-wise in the plug-in direction 6. The extension of the second section 90 in the plug-in direction 6 is smaller than the extension of the first section 88 against the plug-in direction 6. Further, the groove 44 is closed at the end of the second section opposite the first section 88. This end forms a limit stop for the movement into the coupled state C.

The second section 90 of the guiding groove 44 is configured to guide the relative movement of connectors 2, 4 from the intermediate state Ito the coupled state C. It combines a relative rotatory motion of the two connectors 2, 4 along direction 8 with a translational relative motion of the two connectors 2, 4 against the plug-in direction 6. Thus, the second section 90 may at least section-wise be provided with a lead or pitch. The end of the second section 90 which is located to-wards the first section 88 or, equivalently, faces in the rotational direction 8, is offset against the plug-in direction 6 with respect to the end of the second section 90 which is located away from the first section 88, or, equivalently faces against the rotational direction 8.

The second section 90 may in particular be helical. The lead or pitch along the second section 90 is not necessarily constant. In particular, the lead or pitch in a part of the second section 90 that is located closer to the first section 88 may be smaller than in a part of the second section 90 that is more remote from the first section 88. Thus, the lead or pitch along the second section 90 may increase along the circumferential direction 10 or against the direction of rotation 8 away from the first section 88.

The lead or pitch combines the rotatory motion 8 with the translatory motion along the plug-in direction. Increasing the pitch along the rotatory motion 8 reduces the forces that are necessary to move the connectors 2, 4 from the intermediate state I to the coupled state C: First, the connectors 10, 62 are brought into overlap by a rotatory motion 8 having no or only a very small translatory motion against the plug-in direction 6. Each contact 10, 62 enters the respective pocket 69. Thus, the contact sections 68 may be brought into overlap without touching each other. Then, due to an increased or increasing lead or pitch, the contact sections 68 are brought into contact over a very small stretch of rotational motion 8, thus generating only small frictional movements.

To lock the two connectors 2, 4 in the coupled state C, the locking system 46 is provided. The locking system 46 may be as shown in FIG. 12 and as already described with reference to FIGS. 1 and 2.

In FIG. 7, connector 2 is shown without any contact 62. The configuration of the support structure 86 may be substantially the same as with connector 4. Again, the support structure 86 may be combined with the connector 62 to form a pre-mounted unit that is inserted and attached to the connector 2.

With reference to FIGS. 1-7, one or more embodiments include an electric contact assembly having two connectors, which are complementary to each other and are coupled by being plugged together in a plug-in direction and then rotated relative to one another to establish electric contact between a first contact of the first connector and a second contact of the second connector. The connectors are capable of withstanding very high mating cycles. In various embodiments, the electric contact assembly may be used in electric vehicles, such as for use with swappable batteries that need to be disconnected and reconnected to the electric vehicle. The electric contact assembly allows for very high mating cycles by reducing the wear and tear on the contact surfaces.

One or more embodiments provide a connector assembly including two electric connectors that are configured to be plugged together in a plug-in direction and rotated relative to one another in a direction of rotation into a coupled state, wherein the connector assembly includes a mechanical guiding system that is configured to guide the movement of the two electric connectors relative to one another in the plug-in direction and the movement of the two electric connectors relative to one another in the direction of rotation, wherein the mechanical guiding system is further configured to mechanically couple the movement in the direction of rotation with a movement against the plug-in direction, wherein one of the two electric connectors comprises a contact and the other one of the two electric connectors comprises a mating contact and wherein, in the coupled state, the contact and the mating contact are pressed against each other against the plug-in direction.

One or more embodiments provide a method for coupling two electric connectors of a connector assembly, that includes the following steps: moving one of the two electric connectors towards the other one of the two electric connectors in a plug-in direction, thereby plugging the two connectors together; rotating the one of the two electric connectors relative to the other one of the two electric connectors in a direction of rotation; wherein the movement of the two connectors relative to one another in the direction of rotation is mechanically coupled to a movement of the two connectors away from one another against the plug-in direction, thereby pressing a contact of the one of the two electric connectors against a mating contact of the other one of the two electric connectors against the plug-in direction.

The above solution has the advantage that the pressure that acts on the contact and the mating contact to establish electric contact there between does not depend on the force with which the two connectors are plugged together. This allows for an improved control of the contact movement and thus for a better control of the wear and tear of the contact and the mating contact that is caused by the relative contacting motion between the two. Thus, the above solution provides for an increase in the mating cycles.

The following features that may be combined independently with one another may lead to further improvements of the above solution. Each of the following features may be used independently for improvement of the above connector assembly and/or the above method, irrespective of whether the particular feature is mentioned in the context of the connector assembly or the context of the method.

For example, the two electric connectors may be connectors that have an essentially circular footprint or have an overall cylindrical shape. The plug-in direction may be parallel to the axial direction of the overall cylindrical shape or be perpendicular to the essentially circular footprint.

In various embodiments, the plug-in direction is the direction, in which the two connectors are moved towards each other. Thus, the plug-in direction of each connector may be directed towards the respective other connector. A movement against the plug-in direction is, in this context, a movement, in which the two connectors are moved away from one another.

The direction of rotation may be determined for each of the two connectors separately. For each connector, the sense of rotation and thus the direction of rotation is the same. For example, each connector may be rotated clockwise when looking towards the respective other connector. Thus, the direction of rotation of one connector is opposite the direction of the other connector if the other connector is taken as the frame of reference.

The direction of rotation may be directed around the plug-in direction. Thus, the plug-in direction may form the axis of rotation for the direction of rotation. In such a case, the plug-in direction may also be designated as an axial direction.

Determining the plug-in direction and the direction of rotation in the frame of reference of each connector separately allows to unify the description of the two connectors.

The terms contact and mating contact are also to be understood in relation to one another. Of the two contacts that are configured to be in contact with one another in the coupled state, any may be the contact or the mating contact. Once, one of the contacts is termed as a mating contact, the other contact is the contact.

The mechanical guide system may be configured to determine the relative motion of the two electric connectors relative to each other during the entire coupling process. The two electric connectors are positively driven with respect to one another by means of the mechanical guiding system.

In order to be able to be pressed against one another against the plug-in direction, i.e. by a movement of the two connectors away from one another, the contact and the mating contact may overlap in the plug-in direction at least in the coupled state.

During the movement in the plug-in direction, the contact and the mating contact are moved past one another, such as without touching one another. Thus, the contact of the one of the two connectors and the mating contact of the other one of the two connectors do not overlap in the plug-in direction at least as long as the two connectors are moved in the plug-in direction and the contact and the mating contact have not passed each other.

Further, once the contact and the mating contact have moved past one another in the plug-in direction, they may be rotated in the direction of rotation into a position, in which they overlap one another in the plug-in direction.

Further, the contact and the mating contact that overlap one another in the plug-in direction may be moved towards one another against the plug-in direction until they are pressed against each other in the coupled state.

The amount of movement of the two connectors (or of the contact and the mating contact) relative to one another against the plug-in direction per unit angle of rotation, e.g., per degree, may be constant along the direction of rotation during the relative rotational movement of the two connectors in the direction of rotation.

In another embodiment, the amount of movement of the two connectors (or of the contact and the mating contact) relative to one another against the plug-in direction per unit angle of rotation, e.g., per degree, may vary along the direction of rotation during the relative rotational movement of the two connectors in the direction of rotation.

In particular, the amount of movement of the two connectors (or of the contact and the mating contact) relative to one another against the plug-in direction per unit angle of rotation, e.g., per degree, may increase stepwise and/or continuously along the direction of rotation during the relative rotational movement of the two connectors in the direction of rotation.

In the coupled state, the contact of one of the two connectors may be located along the plug-in direction between the mating contact of the other one of the two connectors and a housing of the other one of the two connectors. Thus, the contact and the mating contact may be located behind each other in the respective plug-in direction of the two electric connectors. This allows to first rotate the contact and the mating contact into an overlap in the plug-in direction at the beginning of the rotational movement into the coupled state with no or only little movement of the contact and the mating contact towards one another. Then the contact and the mating contact may be moved quickly into contact over only a small rotational movement. This reduces any scraping of the contacts against one another and thus reduces any wear.

Any one of the two connectors, in particular both connectors, may comprise a pocket in which, in the coupled state, the contact of the respective other connector is located or into which the contact of the respective other connector protrudes along the direction of rotation. The pocket may extend along the plug-in direction. The pocket may be located along the plug-in direction between the contact of a connector and a housing of this connector. The height of the pocket in the plug-in direction should be dimensioned to allow for a movement of the inserted contact against the plug-in direction during the rotational movement.

Further, to allow for the insertion of the contact of the other one of the two connectors during the relative rotational movement of the two electric connectors, the pocket of a connector should be open in the direction of rotation of this connector.

During the movement of the two electric connectors relative to one another in the direction of rotation, a contact of one of the two connectors may be inserted into the pocket of the other one of the two connectors. Thus, the pocket forms a receptacle for the contact of the respective other connector.

The pocket of an electric connector may be limited in the plug-in direction by the contact this connector. In particular, the contact of this connector may form the wall located in the plug-in direction of this pocket opposite the housing of this connector.

According to another embodiment, the connector assembly may have an unplugged state or, equivalently, position and an intermediate state or, equivalently, position, wherein the two connectors are configured to be moved towards each other from the unplugged state to the intermediate state in the (respective) plug-in direction and from the intermediate state to the coupled state in the (respective) direction of rotation. Thus, the two connectors are further spaced apart from one another in the unplugged state than in the intermediate state. In the coupled state each connector is rotated relative to the respective other connector in the direction of rotation as compared to its position relative to the respective other connector in the intermediate state.

Each of the unplugged, intermediate and coupled state corresponds to a different relative position of the two connectors with respect to one another.

In the unplugged state, the two electric connectors may be positioned for being plugged together but not yet be plugged together. In particular, the two electric connectors may be arranged in the unplugged state in a position relative to one another in which the contact and the mating contact do not overlap one another in the plug-in direction. In the intermediate state, the two electric connectors may be plugged together, however, electric contact between the contact and the mating contact is not yet established. The intermediate state may, for example, be located at the end of the movement or travel of the two electric connectors towards each other. In various embodiments, the contact and the mating contact do not overlap each other in the plug-in direction during the entire movement of the unplugged state into the intermediate state.

During the movement from the unplugged state to the intermediate state, a relative rotational movement between the two electric connectors may still be possible. For example, the two electric connectors may rotate relative to one another in the direction of rotation at least once the contact and the mating contact have passed one another in order to combine the movement of the two electric connectors towards one another with a movement of the contact and the mating contact into an overlap in the plug-in direction.

The movement from the intermediate state to the coupled state may not involve any movement of the two connectors towards each other but only a movement of the two connectors relative to one another in the rotational direction and away from one another, i.e. against the plug-in direction.

The mechanical guiding system may, according to another embodiment, include a first section and a second section. The first section may be configured to guide the two connectors relative to one another in the respective plug-in direction. The second section may be configured to guide the two connectors relative to one another against the plug-in direction. At least the second section may be configured to guide the two electric connectors relative to one another in the direction of rotation.

The unplugged state or position may correspond to the beginning of the first section, whereas the intermediate state or position may correspond to the end of the first section and/or the beginning of the second section. In particular, the second section may immediately continue the first section, so that the intermediate section is located at the junction of the first and the second section. The coupled state or position may correspond to the end of the second section.

The mechanical guiding system may include a bayonet coupling. In one specific embodiment, the mechanical guiding system may comprise a guiding groove and a guiding protrusion. The guiding protrusion may be configured complementary to the guiding slot. Further, the guiding protrusion may be configured to slidingly fit into the guiding slot. The guiding slot may thus form a positive guide for the guiding protrusion, the latter being only allowed movement along the slot.

The guiding slot and the guiding protrusion should be located on a different connector, respectively, of the two connectors.

The connector assembly may include at least two guide systems that may be spaced from one another in the circumferential direction and/or the direction of rotation. Using more than two guiding systems increases the stability of the coupling between the two connectors.

The guiding groove may be any kind of slot and/or longitudinal depression. The guide protrusion may, in one embodiment, be a guiding pin, which may be cylindrical.

The first section of the mechanical guiding system may correspond to a first leg of the guiding groove. The second section of the guiding system may correspond to a second leg of the guiding groove. The first and the second section may be joined by a bend. Each leg may be linear or curved. Overall, the guiding groove may extend along an L-shaped curve, with the two legs forming the two legs of the L-shape.

The guiding groove may have an insertion opening or, synonymously, entrance at one end, which may open in the plug-in direction of the respective connector. Further, the guiding groove may have an end which is opposite the insertion opening and may form a limit stop. The unplugged state may be reached if the guiding protrusion is located at the insertion opening of the guiding groove. The coupled state may be reached if the guiding protrusion is located at the limit stop, i.e. at the end of the guiding groove opposite the insertion opening. Thus, the limit stop may define the end of the relative movement of the two connectors in the respective direction of rotation.

In one embodiment, the guiding groove may include a helical section that extends at least section-wise helically around the plug-in direction. In particular, the helical section may be comprised by or correspond to the second section of the guiding system. For example, the helical section may form one leg of the L-shaped guiding groove. The helical section may have a lead or pitch, the lead or pitch determining the rate at which the two connectors are moved relative to one another against the plug-in direction changes per unit angle of rotation along the direction of rotation.

The lead of the helical section may be smaller at a first location in the second section than at a second location in the helical section, where the second location is spaced apart from the first location in the direction of rotation, i.e. is located closer to the coupled state or the end of the second section. More specifically, the lead or pitch of the helical section may increase in the direction of rotation of the respective connector. Thus, the further the two electric connectors are rotated relative to one another along the respective direction of rotation, i.e. the closer to the coupled state, the larger the relative movement against the plug-in direction is per unit rotation.

The first section of the guiding groove may be linear or helical as well. The pitch or lead of the first section is, however, opposite to the pitch or lead of the second section. In various embodiments, however, that the first section of the guiding groove extends linearly along the plug-in direction.

A pitch or lead of the first or second section may vary, for example increase, continuously and/or stepwise, linearly and/or progressively, or stay constant against the direction of rotation.

According to another embodiment, one of the two connectors may include an outer wall and an inner wall. The outer wall may be spaced apart from and/or at least section wise surround the inner wall. Both walls may be cylindrical. In particular, the outer and the inner wall may be concentric.

In various embodiments, the mechanical guiding system is arranged on the outer wall. The inner wall may be sealingly engaged by the other connector. In the coupled state an inner volume of the connector assembly may be sealed off from the environment. In the inner volume, all contacts of the connector assembly may be arranged.

The outer wall may extend beyond the inner wall in the plug-in direction. Both the inner and the outer wall may extend from a bottom wall of the respective connector in the plug-in direction. The connector may extend through the bottom wall.

A locking system may be provided, which is configured to lock or latch the two connectors in the coupled state. In various embodiments, the locking system is arranged at least partly on the outer wall.

The locking system may be configured to block relative rotational movement between the first and the second connector. In particular, the locking system may at least be partly located at the wall at which the guide system is provided, for example, the outer wall.

The locking system may be automatically engaged in the coupled state, e.g., be the relative rotational movement.

The locking system may comprise a locking protrusion, which is received in a locking recess in the coupled state. At least one of the locking protrusion and the locking recess may be elongated in the plug-in direction. For example, the locking protrusion may be an elongated rib. The locking recess may be an elongated groove or slot.

If the locking system is provided e.g., on the outer wall of one connector, it may be preferred that the stiffness is decreased at the location of the locking system, so that the lock or latch can be activated without use of extensive force and the remainder of the outer wall may still be used as protection. For this, the locking protrusion or the locking recess may be located on a latching tongue which is separated from the remainder of the outer wall by two slots. The two slots may extend in the plug-in direction.

At least two or three locking systems may be provided spaced apart from one another in the circumferential direction.

The contact and/or the mating contact may be a bent and stamped metal-sheet part.

The contact of one of the two connectors may comprise a contact section which is configured to contact a contact section of the mating contact of the other one of the two connectors in the coupled state. The contact section may have an end, in particular a free end facing in the direction of rotation. The contact section may be a substantially planar section of the contact and/or the mating contact. The plane of the planar section may be perpendicular to the plug-in direction and/or parallel to the direction of rotation. The contact section of a contact of a connector may be located at the end of the contact that is located in the plug-in direction, i.e. faces towards the respective other connector. At the end of the contact opposite the contact section, i.e. facing away from the respective other connector, a terminal section may be provided which may be configured for attachment of a conductor of a cable.

The contact section of a contact may, in one embodiment, comprise a plurality of tongues which may be elastically deflectable independently of one another along the plug-in direction. The tongues may be parallel to one another and be separated by slots. Each of the tongues and/or slots may extend along the direction of rotation.

It may be advantageous if the contact section comprises a bead or a bulge which protrudes in the plug-in direction. Such a bead or bulge may be beneficial in scratching away any oxidized layer on the other contact. Each of the plurality of tongues may comprise a separate bead or bulge. Only one of a contact and its mating contact may be provided with such a bead or bulge.

Any connector of the two connectors may comprise a support structure that is configured to support a contact of the connector. For example, the support structure may comprise a support, against which the contact, in particular the contact section, is pressed by the mating contact in the coupled state. This support may be a planar section of the support structure that extends parallel to the contact section of the contact. In the coupled state, the contact section is arranged between this support and the contact section of the mating contact.

Additionally or alternatively, the support structure may comprise a support to which the contact is attached. Further additionally or alternatively, the support structure may comprise a support which extends parallel to the plug-in direction and/or perpendicular to the direction of rotation. In the coupled state, the contact is arranged between this support and the mating contact. A section of the contact may abut this support. This support may be used to bear any load that acts on the contact in the direction of rotation. It may extend away from the housing of the connector to-wards the other connector.

The support structure may be a unit that is attached to the housing of the connector as a separate unit. Each contact of the contact assembly may have an identical support structure.

The contact assembly may comprise any number of contacts and mating contacts. In various embodiments, the contacts of one connector are all of the same shape. The support structure may be identical for both connectors.

The various embodiments described are exemplarily with reference to the drawings. The combination of features of the embodiments are just exemplary and may be modified. For example, any of the features may be omitted if the technical effect of this feature is not needed in a specific application. Vice versa, any feature described above in the general part of the description may be independently added to the embodiment described below if the technical effect of this feature is important for a specific application.

The subject matter herein relates to a connector assembly having two electric connectors that are configured to be plugged together in a plug-in direction and rotated relative to one another in a direction of rotation into a coupled state. The subject matter herein also relates to a method of coupling two connectors of a connector assembly. In order to improve the number of mating cycles and thus the service time of the connector assembly, the connector assembly has a mechanical guiding system that is configured to guide the movement of the two electric connectors relative one another in the plug-in direction and the movement of the two electric connectors relative to one another in the direction of rotation. The mechanical guiding system is further configured to mechanically couple the movement in the direction or rotation with a movement against the plug-in direction. One of the two electric connectors has a contact and the other one of the two electric connectors has a mating contact. In the coupled state, the contact and the mating contact are pressed against each other against the plug-in direction.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A connector assembly comprising:
two electric connectors that are configured to be plugged together in a plug-in direction and rotated relative to one another in a direction of rotation into a coupled state, wherein one of the two electric connectors includes a contact and the other one of the two electric connectors includes a mating contact; and
a mechanical guiding system guiding the movement of the two electric connectors relative one another in the plug-in direction and the movement of the two electric connectors relative to one another in the direction of rotation, the mechanical guiding system mechanically coupling the movement in the direction of rotation with a movement against the plug-in direction,
wherein, in the coupled state, the contact and the mating contact are pressed against each other against the plug-in direction.

2. The connector assembly according to claim 1, wherein, in the coupled state, the contact of the one of the two connectors is located along the plug-in direction between the mating contact of the other one of the two connectors and a housing of the other one of the two connectors.

3. The connector assembly according to claim 1, wherein, in the coupled state, the contact of the one of the two connectors is located in a pocket of the other one of the two connectors.

4. The connector assembly according to claim 1, wherein the connector assembly comprises an unplugged state and an intermediate state, wherein the two connectors are configured to be moved towards each other from the unplugged state to the intermediate state in the plug-in direction and from the intermediate state to the coupled state in the direction of rotation,
wherein, during the movement from the unplugged state to the intermediate state, the contact of the one of the two connectors and the mating contact of the other one of the two connectors do not overlap each other in the plug-in direction.

5. The connector assembly according to claim 1, wherein the direction of rotation is directed around the plug-in direction.

6. The connector assembly according to claim 1, wherein the mechanical guiding system comprises a first section and a second section, the first section being configured to guide the one of the two connectors relative to the other one of the two connectors in the plug-in direction, the second section being configured to guide the one of the two connectors relative to the other one of the two connectors in the direction of rotation and against the plug-in direction.

7. The connector assembly according to claim 1, wherein the mechanical guiding system comprises a guiding groove and a guiding protrusion that is configured complementary to the guiding slot and configured to slidingly fit into the guiding slot, the guiding slot and the guiding protrusion each being located on a different connector of the two connectors.

8. The connector assembly according to claim 7, wherein the guiding groove comprises a helical section that extends at least sectionwise helically around the plug-in direction.

9. The connector assembly according to claim 8, wherein the lead of the helical section is smaller at a first location in the helical section than at a second location in the helical section, the second location being spaced apart from the first location in the direction of rotation.

10. The connector assembly according to claim 1, wherein the one of the two connectors comprises an outer wall and an inner wall, the outer wall being spaced apart from and at least sectionwise surrounding the inner wall, the mechanical guiding system being arranged on the outer wall, the inner wall being sealingly engaged by the other one of the two connectors.

11. The connector assembly according to claim 1, wherein the contact of the one of the two connectors and the mating contact of the other one of the two connectors each comprise a contact section, the contact section of the contact being configured to contact the contact section of the mating contact in the coupled state, the contact section of the contact and the contact section of the mating contact each extending in plane that is perpendicular to the plug-in direction and parallel to the direction of rotation.

12. The connector assembly according to claim 1, wherein the contact of one of the two connectors is attached to a support structure, forming a unit that is attached to a housing of this connector.

13. A method for coupling two electric connectors of a connector assembly, the method comprising:
moving the two electric connectors towards each other in a plug-in direction, thereby plugging the two connectors together; and
rotating one of the two electric connectors relative to the other one of the two electric connectors in a direction of rotation into a coupled state;
wherein the relative rotational movement of the two connectors along the direction of rotation is mechanically coupled to a relative movement of the two connectors away from one another against the plug-in direction; and
wherein a contact of one of the two electric connectors is automatically moved towards a mating contact of the other one of the two electric connectors against the plug-in direction during the relative rotational movement in the direction of rotation until, in a coupled sate of the connector assembly the contact and the mating contact are pressed together.

14. The method according to claim 13, wherein, during the movement of two connectors relative to one another in the plug-in direction, the contact and the mating contact are moved past another.

15. The method according to claim 13, wherein, during the rotational movement in the direction of rotation, the rate with which the contact and the mating contact are automatically moved towards each other against the plug-in direction per unit angle of rotation increases.
